(19) United States
(12) Patent Application Publication
(10) Pub. No.: US 2023/0118975 A1
(43) Pub. Date: Apr. 20, 2023

(54) LI-METAL OXIDE/GARNET COMPOSITE THIN MEMBRANE AND METHOD OF MAKING

(71) Applicants: CORNING INCORPORATED, Corning, NY (US); Shanghai Institute of Ceramics, Chinese Academy of Sciences, Shanghai (CN)

(72) Inventors: Michael Edward Badding, Campbell, NY (US); Jun Jin, Shanghai (CN); Zhen Song, Painted Post, NY (US); Jianmeng Su, Shanghai (CN); Zhaoyin Wen, Shanghai (CN); Tongping Xiu, Shanghai (CN); Chujun Zheng, Huizhou City (CN)

(21) Appl. No.: 17/967,338

(22) Filed: Oct. 17, 2022

(30) Foreign Application Priority Data
Oct. 18, 2021 (CN) 202111211196.5

(51) Int. Cl. C04B 35/495; H01M 10/0562

(52) U.S. Cl. CPC C04B 35/495; H01M 10/0562; H01M 2300/0071; C04B 2235/78; C04B 2235/764; C04B 2235/326

(57) ABSTRACT

A sintered composite ceramic includes a lithium-garnet major phase; and a lithium dendrite growth inhibitor minor phase, such that the lithium dendrite growth inhibitor minor phase comprises lithium tungstate. A method includes sintering a metal oxide component and a garnet component at a temperature in a range of 750° C. to 1500° C. to form a sintered composite ceramic.

This application claims the benefit of priority under 35 U.S.C. § 119 of Chinese Patent Application Serial No. 202111211196.5 filed on Oct. 18, 2021, the content of which is relied upon and incorporated herein by reference in its entirety.

### BACKGROUND

### 1. Field

This disclosure relates to lithium-garnet composite ceramic electrolytes with improved critical current density (CCD).

### 2. Technical

Conventional lithium (Li)-ion batteries have been widely studied but still suffer from limited capacity density, energy density, and safety concerns, posing a challenge for large-scale application in electrical equipment. For example, while solid-state lithium batteries based on Li-garnet electrolyte (LLZO) address the safety concerns, insufficient contact between the Li anode and garnet electrolyte due to the rigid ceramic nature and poor lithium wettability of garnet, as well as surface impurities, often lead to large polarization and large interfacial resistances, thereby causing inhomogeneous deposition of lithium and lithium dendrites formation. Due to the existence of pores and defects in LLZO, lithium dendrites may be formed therein and propagating inside the LLZO.

Thus, because grain connections in LLZO are not tight enough and/or the LLZO is not sufficiently dense, the material will exhibit poor dendrite suppression capability and experience low critical current density (CCD), which brings great challenges in solid-state battery applications.

The present application discloses improved lithium-garnet composite ceramic electrolytes for enhanced grain boundary bonding of Li-garnet electrolytes in solid-state lithium metal battery applications.

### SUMMARY

In embodiments, a sintered composite ceramic, comprises a lithium-garnet major phase; and a lithium dendrite growth inhibitor minor phase, wherein the lithium dendrite growth inhibitor minor phase comprises lithium tungstate.

In aspects, which are combinable with any of the other aspects or embodiments, the lithium-garnet major phase comprises at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi, Ca, or Y and 0<b<1; (iii) Li_{7-c}La₃(Zr_{2-c}, N_{c})O₁₂, with N=In, Si, Ge, Sn, Sb, Sc, Ti, Hf, V, W, Te, Nb, Ta, Al, Ga, Fe, Bi, Y, Mg, Ca, or combinations thereof and 0<c<1, or a combination thereof.

In aspects, which are combinable with any of the other aspects or embodiments, the lithium tungstate comprises a formula of LiₓWO_{(x+6)/2}, where ⅓≤x≤6 (LWO). In aspects, which are combinable with any of the other aspects or embodiments, the lithium tungstate comprises at least one of: Li₂WO₄, Li₄WO₅, Li₆WO₆, Li₂W₂O₇, Li₂W₄O₁₃, Li₂W₆O₁₅, or a combination thereof. In aspects, which are combinable with any of the other aspects or embodiments, the lithium-garnet major phase comprises at least 90 wt. % of a lithium garnet cubic phase. In aspects, which are combinable with any of the other aspects or embodiments, a maximum grain size measured for a population of grains representing at least 5% of a total grain population does not exceed an average grain size of the total grain population by more than a multiple of 20.

In aspects, which are combinable with any of the other aspects or embodiments, a battery, comprises at least one lithium electrode; and an electrolyte in contact with the at least one lithium electrode, wherein the electrolyte is a lithium-garnet composite electrolyte comprising the sintered composite ceramic disclosed herein. In aspects, which are combinable with any of the other aspects or embodiments, the battery has an ionic conductivity greater than 0.4 mS·cm⁻¹. In aspects, which are combinable with any of the other aspects or embodiments, the battery has a relative density greater than 97%. In aspects, which are combinable with any of the other aspects or embodiments, the battery has a critical current density (CCD) greater than 0.7 mA·cm⁻².

In embodiments, a method comprises sintering a metal oxide component and a garnet component at a temperature in a range of 750° C. to 1500° C. to form a sintered composite ceramic, comprising: a lithium-garnet major phase; and a lithium dendrite growth inhibitor minor phase, wherein the lithium dendrite growth inhibitor minor phase comprises lithium tungstate.

In aspects, which are combinable with any of the other aspects or embodiments, the temperature is in a range of 1000° C. to 1250° C. In aspects, which are combinable with any of the other aspects or embodiments, the temperature is in a range of 1130° C. to 1230° C. In aspects, which are combinable with any of the other aspects or embodiments, prior to the step of sintering, mixing the metal oxide component and the garnet component such that a lithium-to-tungsten molar ratio (Li:W) is in a range of ⅓≤x≤6. In aspects, which are combinable with any of the other aspects or embodiments, the sintering is conducted for a time in a range of 1 min to 300 min. In aspects, which are combinable with any of the other aspects or embodiments, the sintering time is in a range of 5 min to 100 min. In aspects, which are combinable with any of the other aspects or embodiments, the sintering further comprises adding a garnet-type mother powder. In aspects, which are combinable with any of the other aspects or embodiments, the lithium tungstate comprises a formula of LiₓWO_{(x+6)/2}, where ⅓≤x≤6 (LWO). In aspects, which are combinable with any of the other aspects or embodiments, the lithium tungstate comprises at least one of: Li₂WO₄, Li₄WO₅, Li₆WO₆, Li₂W₂O₇, Li₂W₄O₁₃, Li₂W₆O₁₅, or a combination thereof.

### BRIEF DESCRIPTION OF THE DRAWINGS

The disclosure will become more fully understood from the following detailed description, taken in conjunction with the accompanying figures, in which:

FIG. 1 illustrates an x-ray diffraction (XRD) pattern of Li-garnet composite ceramic electrolyte as in Samples 1-3, according to embodiments.

FIG. 2 illustrates a cross-sectional scanning electron microscopy (SEM) image of Comparative Sample 1, according to embodiments.

FIGS. 3A and 3B illustrate cross-sectional SEM images of Sample 2, according to embodiments.

FIGS. 4A-4F illustrate critical current density (CCD) tests for all solid-state lithium symmetrical batteries of Samples 2 and 4-8, respectively, according to embodiments.

FIG. 5 illustrates Raman spectra of Samples 1-3 and Comparative Sample 1, according to embodiments.

FIGS. 6A-6D illustrate cross-sectional analysis of Sample 3, including SEM (FIG. 6A) and energy dispersive spectroscopy (EDS) for elemental mapping of zirconium (Zr) (FIG. 6B), tungsten (W) (FIG. 6C), and lanthanum (La) (FIG. 6D), according to embodiments.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments. It should be understood that the present application is not limited to the details or methodology set forth in the description or illustrated in the figures. It should also be understood that the terminology is for the purpose of description only and should not be regarded as limiting.

Additionally, any examples set forth in this specification are illustrative, but not limiting, and merely set forth some of the many possible embodiments of the claimed invention. Other suitable modifications and adaptations of the variety of conditions and parameters normally encountered in the field, and which would be apparent to those skilled in the art, are within the spirit and scope of the disclosure.

### Definitions

“Major phase,” “first phase,” or like terms or phrases refer to a physical presence of a lithium garnet in greater than 50 wt. %. Phase components and their concentrations may be measured by XRD (wt. %). In some examples, major phase may also be represented by a physical presence of a lithium garnet in greater than 50 vol. % or greater than 50 mol. %, or like in the composition.

“Minor phase,” “second phase,” or like terms or phrases refer to a physical presence of a lithium dendrite growth inhibitor (i.e., grain boundary bonding enhancer) in less than 50% by weight, by volume, by mols, or like measures in the composition. In some examples, minor phases not detectable by XRD, may be measured by SEM to confirm existence of the minor phase(s).

“SA,” “second additive,” “second phase additive,” “second phase additive oxide,” “phase additive oxide,” “additive oxide,” “additive,” or like terms refer to an additive oxide that produces a minor phase or second minor phase within the major phase when included in the disclosed compositions.

“LLZO,” “garnet,” or like terms refer to compounds comprising lithium (Li), lanthanum (La), zirconium (Zr), and oxygen (O) elements. Optionally, dopant elements may substitute at least one of Li, La, or Zr.

For example, lithium-garnet electrolyte comprises at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi, Ca, or Y and 0<b<1; (iii) Li_{7-c}La₃(Zr_{2-c},N_{c})O₁₂, with N=In, Si, Ge, Sn, V, W, Te, Nb, or Ta and 0<c<1; (iv) Li₇₋ₓLa₃(Zr₂₋ₓ, Mₓ)O₁₂, with M=In, Si, Ge, Sn, Sb, Sc, Ti, Hf, V, W, Te, Nb, Ta, Al, Ga, Fe, Bi, Y, Mg, Ca, or combinations thereof and 0<x<1, or a combination thereof.

“Include,” “includes,” or like terms means encompassing but not limited to, that is, inclusive and not exclusive.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

For example, in modifying the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, “about” or similar terms refer to variations in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” (or similar terms) also encompasses amounts that differ due to aging of a composition or formulation with a particular initial concentration or mixture and amounts that differ due to mixing or processing a composition or formulation with a particular initial concentration or mixture.

As utilized herein, “optional,” “optionally,” or the like are intended to mean that the subsequently described event or circumstance can or cannot occur, and that the description includes instances where the event or circumstance occurs and instances where it does not occur. The indefinite article “a” or “an” and its corresponding definite article “the” as used herein means at least one, or one or more, unless specified otherwise.

As used herein, “room temperature” or “RT” is intended to mean a temperature in a range of about 18° C. to 25° C.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

Abbreviations, which are well known to one of ordinary skill in the art, may be used (e.g., “h” or “hrs” for hour or hours, “g” or “gm” for gram(s), “mL” for milliliters, and “RT” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The compositions, articles, and methods of the disclosure can include any value or any combination of the values, specific values, more specific values, and preferred values described herein, including explicit or implicit intermediate values and ranges.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

As explained above, solid-state lithium batteries based on Li-garnet electrolyte (LLZO) often suffer from insufficient contact between the Li anode and garnet electrolyte, which often leads to the battery experiencing a low critical current density (CCD) and eventual short circuiting. Conventional approaches to address these issues have included: (A) H₃PO₄ acid treatments for removing impurities while forming a protective interlayer of Li₃PO₄ and (B) modifying the electrolyte-anode interface with SnO₂ and MoS₂ to form Sn, Mo, and related alloy interlayers. However, it was found that for these proposals, as the battery circulates, the interlayers gradually become exhausted and result in eventual battery failure. Moreover, these interlayers do not increase the resistance of the electrolyte itself against lithium dendrite growth.

Composite ceramic electrolytes are effective in improving bonding at the major phase grain boundary, thereby improving CCD by minimizing lithium dendrite growth. Critical current density (CCD) refers to the maximum current density that LLZO electrolyte can tolerate before lithium dendrite penetration occurs in the electrolyte, which affects the dendrite suppression capability of the electrolyte. By adding additives during the LLZO sintering process, the additive or its decomposition product aggregates at the grain boundary to enhance grain boundary bonding and block lithium dendrite growth. Current efforts at studying additives have included (i) LiOH.H₂O in LLZO to form a minor phase of Li₂CO₃ and LiOH or (ii) adding Li₃PO₄ to LLZO precursor and allowing Li₃PO₄ to remain as the minor phase at the grain boundaries by controlling sintering conditions or (iii) adding LiAlO₂-coated LLZO particles to obtain a Li-garnet composite ceramic electrolyte. However, none of (i) to (iii), can achieve a desired CCD to meet the requirements of practical applications.

Garnet is a promising solid electrolyte material for Li-metal battery technology. Li metal anodes allow a much higher energy density than the carbon anodes currently used in conventional Li-ion batteries. Challenges exist in methods of making thin garnet materials. For example, one challenge is Li-dendrite formation, as explained above. A second challenge is the strength requirement for thin membranes, which is determined by battery assembly handling. A fine grain microstructure is desired for high strength.

Disclosed herein is a Li-garnet composite ceramic thin membrane for electrolyte applications prepared by adding a metal oxide into LLZO with optional elemental doping (e.g., at least one of In, Si, Ge, Sn, Sb, Sc, Ti, Hf, V, W, Te, Nb, Ta, Al, Ga, Fe, Bi, Y, Ca, etc., or combinations thereof). Elemental dopants may be used to stabilize LLZO into a cubic phase.

Li-metal-oxides may be used as the grain boundary materials for grain boundary modification such that non- or low-Li-ion conductive material may be used to fill garnet grain boundaries so that Li-ions preferably penetrate through the garnet grains, thereby inhibiting Li-dendrite growth through the grain boundary and inhibiting solid electrolyte critical current densities (CCDs). Low melting temperature of the second phase material may also help to decrease garnet sintering temperature and increase grain bonding strength.

In some examples, the Li-garnet composite ceramic may comprise: a lithium garnet major phase (e.g., LLZO, as defined above) and a lithium dendrite growth inhibitor minor phase (e.g., SA, as defined above). In some examples, the major phase may be doped with at least one of In, Si, Ge, Sn, Sb, Sc, Ti, Hf, V, W, Te, Nb, Ta, Al, Ga, Fe, Bi, Y, Mg, Ca, or combinations thereof and the minor phase comprises a second additive oxide selected from the group Li-silicate, Li-gallate, Li-aluminate, Li-tungstate, Li-molinate, Li—Ta oxide, Li—Nb-oxide, Li—Sn-oxide, Li—In-oxide, Li—As-oxide, Li—Sb-oxide, Li-phosphate, or combinations thereof, present in from >0-10 wt. % based on the total amount of the ceramic. The additive may improve uniformity of the ceramic microstructure and enhance mechanical properties of the ceramic. As used herein “uniformity of the ceramic microstructure” refers to the distribution of grain sizes. The occurrence of abnormally large grains, which can have a detrimental effect on mechanical properties, may be minimized or eliminated and a fine grain microstructure may be achieved. For example, the maximum grain size measured for a population of grains representing at least 5% of the total grains should not exceed the average grain size by more than a multiple of 20.

As disclosed herein, a process of making a dense, fine-grain metal oxide/garnet composite thin membrane structure is described with an identified composite composition that results in a test cell having improved CCD, as compared with cells not comprising the metal oxide/garnet composite thin membrane.

The following Examples demonstrate making, use, and analysis of the disclosed ceramics.

### Examples

As explained above, solid-state batteries (SSBs) using solid-state electrolytes (SSEs) with matching high-voltage cathodes and lithium metal anodes are strong candidates for the next-generation battery technique, having potential to surpass the capacity limits of conventional lithium-ion batteries and satisfy the demands of higher power and energy density in electric transportation. As a key component in SSBs, different types of SSEs have been reported. With high room-temperature ionic conductivity, fine thermal stabilities, wide electrochemical window as well as good chemical stability against lithium metal, LLZO is expected to be an ideal electrolyte material for solid lithium metal batteries.

However, LLZO ceramics prepared by conventional, pressure-less, sintering generally have severe abnormal grain growth (AGG) or low density (<92%), which results in low ionic conductivity and very low mechanical strength. Such low-quality LLZO cannot be used in SSBs. To date, quite a few approaches have been developed, including hot pressing (HP) or spark plasma sintering (SPS) techniques, to obtain high-quality LLZO. HP or SPS can eliminate the pores and increase the relative density of LLZO to over 99%. However, the required equipment is very expensive and the cost to manufacture is high. Scaling-up is difficult for both HP and SPS approaches. Sintering aids have also been adopted to promote density during pressure-less sintering, though sintering aids have only resulted in limited improvement to ion conductivity and density of LLZO. The achieved relative density of the obtained electrolyte from using sintering aids does not meet the requirements of practical applications. Therefore, novel additives with both high sintering activity and density-increasing ability are desired.

Disclosed herein is a Li-garnet composite ceramic electrolyte with high density. LiₓWO_{(x+6)/2} (⅓≤x≤6) additive is added into LLZO powder to improve sintering activity and to increase the density of the composite electrolyte under pressure-less sintering.

### Example 1—Preparation of Li-Garnet Powder

Step 1: First Mixing Step

In the first mixing step, a stoichiometric amount of inorganic materials is mixed together, in the formula of garnet oxides and, for example, milled into fine powder. The inorganic materials can be a carbonate, a sulfonate, a nitrate, an oxalate, a hydroxide, an oxide, or mixtures thereof with the other elements in the chemical formula. For example, the inorganic materials can be, for example, a lithium compound and at least one transition metal compound (e.g., La-based, Zr-based, etc.). In some embodiments, the inorganic materials compounds may also comprise at least one of In, Si, Ge, Sn, Sb, Sc, Ti, Hf, V, W, Te, Nb, Ta, Al, Ga, Fe, Bi, Y, Mg, Ca, or combinations thereof in the chemical formula.

In some embodiments, it may be desirable to include an excess of a lithium source material in the starting inorganic batch materials to compensate for the loss of lithium during the high temperature of from 1000° C. to 1300° C. (e.g., 1100° C. to 1200° C.) sintering/second calcining step. The first mixing step can be a dry mixing process (e.g., tubular mixing followed by dry ball milling, or vice versa), dry milling process, or a wet milling process with an appropriate liquid that does not dissolve the inorganic materials. The mixing time, such as from several minutes to several hours, can be adjusted, for example, according to the scale or extent of the observed mixing performance (e.g., 1 min to 48 hrs, or 30 mins to 36 hrs, or 1 hr to 24 hrs (e.g., 12 hrs), or any value or range disclosed therein). The milling can be achieved by, for example, a planetary mill, an attritor, ball mixing, tubular mixing, or like mixing or milling apparatus.

Step 2: First Calcining Step

In the first calcining step, the mixture of inorganic material, after the first mixing step, is calcined at a predetermined temperature, for example, at from 800° C. to 1200° C. (e.g., 950° C.), including intermediate values and ranges, to react and form the target Li-garnet. The predetermined temperature depends on the type of the Li-garnet. The calcination time, for example, varies from 1 hr to 48 hrs (e.g., 2 hrs to 36 hrs, or 3 hrs to 24 hrs, or 4 hrs to 12 hrs (e.g., 6 hrs), or any value or range disclosed therein), and also may depend upon on the relative reaction rates of the selected inorganic starting or source batch materials. In some examples, the predetermined temperature is selected independently from the calcination time, for example, 950° C. for 6 hrs or 1200° C. for 5 hrs. In some embodiments, a pre-mix of inorganic batch materials can be milled and then calcinated or calcined, as needed, in a first step.

Step 3: Second Calcining Step

After the first calcining step, the calcined mixture of inorganic material may optionally be calcined at a higher predetermined temperature for example, at from 1000° C. to 1300° C. (e.g., 1200° C.), including intermediate values and ranges, with a temperature ramping rate (pre-sintering) and cooling rate (post-sintering) ranging from 0.5° C./min to 10° C./min (e.g., 5° C./min). The predetermined temperature for the second calcining depends on the type of the Li-garnet. The calcination time, for example, varies from 1 hr to 48 hrs (e.g., 2 hrs to 36 hrs, or 3 hrs to 24 hrs, or 4 hrs to 12 hrs (e.g., 5 hrs), or any value or range disclosed therein). In some examples, Steps 2 and 3 may be combined into a single calcining step with two holding phases (the first holding phase represented by Step 2 and the second holding phase represented by Step 3).

Steps 1-3 may be implemented herein where a precursor powder LiOH.H₂O (AR, 2% excess), La₂O₃ (99.99%, calcined at 900° C. for 12 hours), ZrO₂ (AR), and Ta₂O₅ (99.99%) are used according to a stoichiometric ratio of Li_{6.5}La₃Zr_{1.5}Ta_{0.5}O₁₂ weighing. Wet ball milling is carried out for 12 hours using yttrium-stabilized zirconia (YSZ) balls as a grinding medium at a speed of 250 rpm using isopropanol as the solvent. The dried mixture power was calcined in an alumina crucible at 950° C. for 6 hours to obtain pure cubic Li-garnet electrolyte powder. Preferably, the solid electrolyte is a Li-garnet ceramic electrolyte LLZO according to a chemical formula defined above.

### Example 2—Preparation of Second Additive Powder

Step 4: Second Mixing Step

In the second mixing step, a stoichiometric amount of inorganic materials is mixed together, in the formula of the second additive and, for example, milled into fine powder. The inorganic materials can be a carbonate, a sulfonate, a nitrate, an oxalate, a hydroxide, an oxide, or mixtures thereof with the other elements in the second additive chemical formula. For example, the inorganic materials can be, for example, a lithium compound and at least one transition metal compound (e.g., W-based, etc.).

The second mixing step can be a dry mixing process (e.g., tubular mixing followed by dry ball milling, or vice versa), dry milling process, or a wet milling process with an appropriate liquid that does not dissolve the inorganic materials. The mixing time, such as from several minutes to several hours, can be adjusted, for example, according to the scale or extent of the observed mixing performance (e.g., 1 min to 48 hrs (e.g., 24 hrs), or 30 mins to 36 hrs, or 1 hr to 24 hrs, or any value or range disclosed therein). The milling can be achieved by, for example, a planetary mill, an attritor, ball mixing, tubular mixing, or like mixing or milling apparatus.

Step 5: Third Calcining Step

In the third calcining step, the mixture of inorganic material, after the second mixing step, is calcined at a predetermined temperature, for example, at from 250° C. to 750° C. (e.g., 500° C.), including intermediate values and ranges. The predetermined temperature depends on the type of the second additive. The calcination time, for example, varies from 1 min to 12 hrs (e.g., 30 min to 9 hrs, or 1 hr to 6 hrs, or 1 hr to 3 hrs (e.g., 2 hrs), or any value or range disclosed therein), and also may depend upon on the relative reaction rates of the selected inorganic starting or source batch materials. In some examples, the predetermined temperature is selected independently from the calcination time, for example, 500° C. for 2 hrs.

Steps 4 and 5 may be implemented herein where the precursor powder LiOH.H₂O (AR) and WO₃ (AR) were weighed at a molar ratio of x (⅓≤x≤6). Wet ball milling was carried out for 24 hrs by using YSZ beads as a grinding medium at a speed of 250 rpm using isopropanol as a solvent. The dried mixture power was calcined in alumina crucible at 500° C. for 2 hours. The second additive may comprise a formula of LiₓWO_{(x+6)/2}, where ⅓≤x≤6 (LWO), such as Li₂WO₄, Li₄WO₅, Li₆WO₆, Li₂W₂O₇, Li₂W₄O₁₃, and Li₂W₆O₁₅.

### Example 3—Preparation of Garnet-Type Mother Powder

High temperature is essential for preparing dense LLZO electrolyte (1100-1300° C.). However, lithium loss is severe at such high temperatures. In addition to or in lieu of the excess lithium source material in Example 1, garnet-type mother powder may be used to compensate LLZO garnet samples' Li loss during sintering processes. Addition of a garnet-type mother powder also helps to obtain high density LLZO. In examples, the garnet-type mother powder comprises at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi, Ca, or Y and 0<b<1; (iii) Li_{7-c}La₃(Zr_{2-c},N_{c})O₁₂, with N=In, Si, Ge, Sn, V, W, Te, Nb, or Ta and 0<c<1; (iv) Li₇₋ₓLa₃(Zr₂₋ₓ, Mₓ)O₁₂, with M=In, Si, Ge, Sn, Sb, Sc, Ti, Hf, V, W, Te, Nb, Ta, Al, Ga, Fe, Bi, Y, Mg, Ca, or combinations thereof and 0<x<1, or a combination thereof. For example, the garnet-type mother powder may have a formula of Li_{6.75}La₃Zr_{1.75}Nb_{0.25}O₁₂ (LLZNO).

Synthesis of the garnet-type mother powder is similar as the process for preparing the Li-garnet powder of Example 1, except the excessive lithium amount is 15%. For example, precursor powders were mixed at 250 rpm for 12 hrs (Step 1), and dried and calcinated at 950° C. for 6 hrs (Step 2).

### Example 4—Preparation of Li-Garnet Composite Ceramic Electrolyte

Step 6: Third Mixing Step

The third mixing step is similar to Step 1 of Example 1 above for the mixing of the Li-garnet powder of Example 1 and the second additive powder of Example 2. Initially, the Li-garnet (e.g., LLZO) powder and the second additive (LWO) powder are weighed according to a predetermined ratio (e.g., Li:W molar ratio of ⅓≤x≤6) and wet-milled at 250 rpm for 12 hrs.

Step 7: Sieving Step

The obtained mixture from Step 6 is dried 70° C. for 12 hrs and then filtered by passing through a 200-grit sieve and thereafter, uniaxially pressed at a pressure of 100 MPa to form a green pellet having a diameter in a range of 0.1 mm to 100 mm, or 1 mm to 50 mm (e.g., 18 mm), or 10 mm to 25 mm. The green pellet may have a weight in a range of 0.01 g to 50 g, or 0.1 g to 25 g, or 1 g to 10 g (e.g., 1.25 g). Where the green pellet is formed as an arbitrary shape, the pellet may have at least one dimension ranging from 0.1-100 mm.

Step 8: Green Pellet Sintering

During sintering, green pellets were carried in an Al₂O₃, MgO or Pt crucible and sintered at different temperatures, with garnet-type mother powder of Example 3 (e.g., LLZNO) being used to compensate for the loss of lithium from the LLZO garnet (e.g., 0.2 g garnet-type mother powder for each LLZO pellet). Two types of sintering methods may be used: conventional sintering and fast sintering. In conventional sintering, the temperature ramping rate is in a range of 100° C./hr to 600° C./hr (in an air environment, argon (Ar), or nitrogen (N₂) atmosphere). In fast sintering, the temperature ramping rate is in a range of 100° C./min to 1000° C./min (in an air environment).

Step 8 may be implemented at temperatures in a range of 750° C. to 1500° C., or 900° C. to 1400° C., or 1000° C. to 1250° C. (e.g., 1130° C. to 1230° C.), or any value or sub-range disclosed therein, for a time in a range of 1 min to 300 min, or 5 min to 100 min, or 10 min to 50 min (e.g., 30 min), or any value or sub-range disclosed therein to form the Li-garnet composite ceramic electrolyte. Temperature ramping and cooling rate during the sintering were both at 5° C./min.

### Example 5—Formation of Li/LLZO-LWO/Li Symmetrical Battery

All the electrolyte pellets were polished with 400 grit, 800 grit and then 1200 grit SiC sandpaper, followed by sputtering Au on both side surfaces for 5 min, and then transferring into an argon-filled glove box. To assemble the battery cell, lithium metal foil is placed at a center of one LLZO-LWO sample surface and heated to 250-300° C. on a hot plate to spread molten lithium on the surface of the pellet. The pellet is rotated 180° the process is repeated with a second lithium metal foil. The Li/LLZO-LWO/Li symmetrical battery is finally sealed in a CR2032 coin cell for characterization studies.

### Example 6—Characterization

Morphology and Phase Analysis

SEM images were obtained by scanning electron microscope (SEM, Hitachi, S-3400 N). Element mapping images were characterized by energy dispersive spectrometer (EDS) affiliated with the HITACHI SEM. XRD patterns were obtained by X-ray powder diffraction (Rigaku, Ultima IV, nickel-filtered Cu-Kα radiation, λ=1.542 Å) in the 20 range of 10-80° at room temperature. Density of the ceramic samples was measured by the Archimedes method using ethanol as the immersion medium.

Electrochemical Impedance Spectroscopy

Electrochemical impedance spectroscopy (EIS) was measured by AC impedance analysis (Autolab, Model PGSTAT302 N) with a frequency range of 0.1 Hz-1 MHz.

Electrochemical Performance

All Li symmetric cells and full batteries were tested on a Neware battery test system (NEWARE CT-4008 Shenzhen, China). The Li/LLZO-LWO/Li symmetrical battery was subjected to a rate cycling test at an initial current density of 0.1 mA·cm⁻² in 0.1 mA·cm⁻² increments to determine the critical current density of LLZO-LWO. The charge and discharge durations were set to 30 minutes. All battery tests were performed at 25° C.

### Example 7—Sample Preparation

Sample 1

The Li-garnet electrolyte LLZO and the lithium-tungsten composite oxides LWO (Li₂WO₄, LWO) were ball milled at a mass ratio of 100:1 (40 g of LLZO, 0.4 g of LWO with 120 g isopropyl alcohol). The LLZO powder and the LWO powder were weighed in a predetermined ratio and wet-milled at 250 rpm for 12 hrs. The particle size distribution D90 was between 1.2 μm and 1.7 μm. The obtained mixture was dried at 70° C. for 12 hrs and then passed through a sieve of 200 grit. A green pellet having a diameter of 18 mm was formed by uniaxial pressing at a pressure of 100 MPa. A green pellet weighs 1.25 g. Thereafter, the green body was placed in a Pt crucible and sintered at 1230° C. for 30 min. Each LLZO green body was sintered with 0.2 g garnet type mother powder (Li_{6.75}La₃Zr_{1.75}Nb_{0.25}O₁₂, LLZNO, with 15% Li excess). The synthesis process for the LLZNO powder is similar to that for preparing the LLZO powder as described above except the excessive lithium amount is 15%. The temperature ramping and cooling rates during the sintering were both 5° C./min.

Sample 2

Same as that in Sample 1, except that the Li-garnet electrolyte LLZO and the lithium-tungsten composite oxides LWO were ball milled at a mass ratio of 100:2.

Sample 3

Same as that in Sample 1, except that the Li-garnet electrolyte LLZO and the lithium-tungsten composite oxides LWO were ball milled at a mass ratio of 100:4.

Sample 4

Same as that in Sample 2, except that the green body was placed in a Pt crucible and sintered at 1210° C. for 30 min.

Sample 5

Same as that in Sample 2, except that the green body was placed in a Pt crucible and sintered at 1190° C. for 30 min.

Sample 6

Same as that in Sample 2, except that the green body was placed in a Pt crucible and sintered at 1170° C. for 30 min.

Sample 7

Same as that in Sample 2, except that the green body was placed in a Pt crucible and sintered at 1150° C. for 30 min.

Sample 8

Same as that in Sample 2, except that the green body was placed in a Pt crucible and sintered at 1130° C. for 30 min.

Comparative Sample 1

The Li-garnet electrolyte LLZO powder was milled at 250 rpm for 12 hrs. The particle size distribution D90 was between 1.2 μm and 1.7 μm. The obtained mixture was dried at 70° C. for 12 hrs and then passed through a sieve of 200 grit. A green pellet having a diameter of 18 mm was formed by uniaxial pressing at a pressure of 100 MPa. A green pellet weighs 1.25 grams. Thereafter, the green body was placed in a Pt crucible and sintered at 1170° C. for 30 min. Each LLZO pellet was sintered with 0.2 g garnet-type mother powder (Li_{6.75}La₃Zr_{1.75}Nb_{0.25}O₁₂, LLZNO, with 15% Li excess). The synthesis process for the LLZNO powder is similar to that for preparing the LLZO powder as described above except the excessive lithium amount is 15%. The temperature ramping and cooling rates during the sintering were both 5° C./min.

Comparative Sample 2

Same as that in Comparative Sample 1, except that the green body was placed in a Pt crucible and sintered at 1230° C. for 30 min.

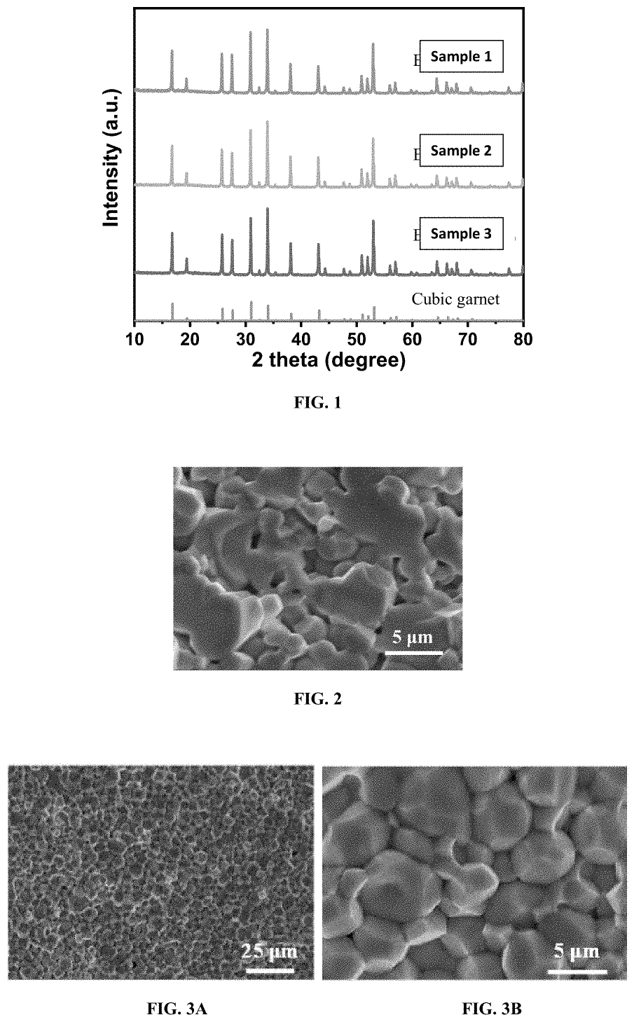

FIG. 1 illustrates an x-ray diffraction (XRD) pattern of Li-garnet composite ceramic electrolyte as in Samples 1-3. The XRD peaks match well with standard cubic Li-garnet electrolyte (PDF #45-0109), indicating that addition of LWO as a second phase does not affect the LLZO phase, which is retained in terms of structural integrity.

FIG. 2 illustrates a cross-sectional scanning electron microscopy (SEM) image of Comparative Sample 1. Grain boundaries between grains are indistinct (i.e., without a clear crystalline profile), and there exists pores within the electrolyte body, indicating that LLZO has not been fully sintered. The lack of a clear crystalline profile may be due to the sintering temperature (1170° C. for Comparative Sample 1) being too low to reach the LLZO densification temperature. On the contrary, samples sintered at higher temperatures (e.g., 1230° C.) have denser structures and well-grown grains with smooth facets and clear grain profile (e.g., Sample 2).

FIGS. 3A and 3B illustrate cross-sectional SEM images of Sample 2. When LWO is added, LLZO is shown to have a dense structure with few pores, well-grown grains with smooth facets and clear grain profile, and tightly-bonded crystal grains. Relative density and ionic conductivity may also be used to quantify the difference between Comparative Sample 1 and Sample 2 (see Table 1).

Table 1 lists the performance of Samples 1-8 and Comparative Samples 1 and 2.

TABLE 1

| | | | | Ionic | |
|---|---|---|---|---|---|
| | LWO/ | | | Conduc- | |
| | LLZO | | Relative | tivity | CCD |
| | Mass | Sintering | Density | (mS · | (mA · |
| Sample | Ratio | Condition | (%) | cm⁻¹) | cm⁻²) |
| Compar- | 0 | 1170° C., 30 min | 92.2 | 0.481 | 0.3 |
| ative 1 | | | | | |
| Compar- | 0 | 1230° C., 30 min | 96.07 | 0.714 | 0.5 |
| ative 2 | | | | | |
| 1 | 1:100 | 1230° C., 30 min | 97.33 | 0.679 | 0.7 |
| 2 | 2:100 | 1230° C., 30 min | 98.25 | 0.625 | 0.9 |
| 3 | 4:100 | 1230° C., 30 min | 97.21 | 0.510 | 0.7 |
| 4 | 2:100 | 1210° C., 30 min | 98.45 | 0.652 | 0.9 |
| 5 | 2:100 | 1190° C., 30 min | 98.42 | 0.618 | 0.9 |
| 6 | 2:100 | 1170° C., 30 min | 98.67 | 0.599 | 1.0 |
| 7 | 2:100 | 1150° C., 30 min | 98.36 | 0.501 | 0.8 |
| 8 | 2:100 | 1130° C., 30 min | 98.07 | 0.427 | 0.8 |

All of Samples 1-8 have ionic conductivity in excess of 0.4 mS·cm⁻¹, a relative density in excess of 97%, and a critical current density (CCD) in excess of 0.7 mA·cm⁻². These values ensure solid-state electrolytes (e.g., LLZO) will transmit Li⁺ in solid-state lithium metal batteries. Moreover, Samples 1-8, which include some quantities of LWO, effectively improves electrolyte relative density and CCD. In contrast, Comparative Samples 1 and 2 have a low relative density (<97%) and low CCD (<0.5 mA cm⁻²). It is difficult to obtain a density of greater than 96%, however, addition of LWO (e.g., 2 wt. %) allows significant improvement of LLZO relative density (e.g., >98%).

Intrinsic properties of LLZO is a factor in determining dendrite-suppression ability. Due to pores and defects in LLZO, dendrites may be formed in these sites and propagate inside the LLZO, which is problematic in SSB applications. High density LLZO results in tighter grain contact and less porosity. Relative density is related to CCD, and high relative density is one basic requirement for engineering high CCD. By adding LWO (e.g., 2 wt. %), CCD of LLZO obtained under the same sintering conditions as LLZO without adding LWO, increased by 80% when sintered at 1230° C. (0.5→0.9 mA·cm⁻²) and 233% when sintered at 1170° C. (0.3→1.0 mA·cm⁻²).

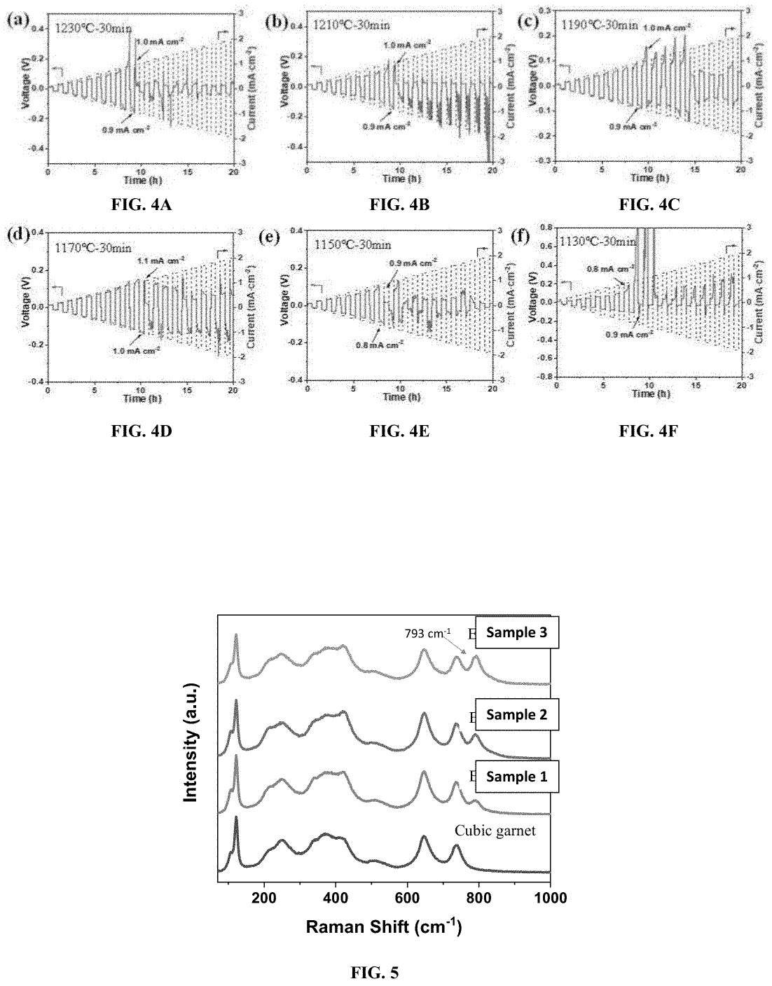

FIGS. 4A-4F illustrate critical current density (CCD) tests for all solid-state lithium symmetrical batteries of Samples 2 and 4-8, respectively. CCDs of the composite ceramics obtained at different sintering temperatures are all in the range of 0.8˜1.0 mA·cm⁻², indicating that electrolytes with stable performance can be obtained in a wide temperature range. The wide temperature range is relative to the Comparative Samples. For the Comparative Samples, sintering temperature range is very narrow and pristine LLZO sintered at 1230° C. (as in Comparative Sample 2) has the best comprehensive performance. However, when sintering temperature decreases to 1170° C. (as in Comparative Sample 1), pristine LLZO performance is significantly reduced (see Table 1: relative density reduces from 96.07% to 92.2%; CCD reduces from 0.5 mA·cm⁻² to 0.3 mA·cm⁻²). By adding LWO (e.g., 2 wt. %), CCDs of the composite ceramics obtained at different sintering temperatures are all in a range of about 0.8 to 1.0 mA·cm⁻², and all of Samples 2 and 4-8 have a relative density in excess of 98%, indicating that electrolytes with stable performance can be obtained in a wide temperature range. The CCD of garnet approaches 1.0 mA·cm⁻² for Sample 6 (LWO-to-LLZO mass ratio of 2/100 and sintered at 1170° C.). Composite garnet electrolyte has a higher CCD than that of pristine garnet because of tighter bonding enabled by addition of a second phase (in this case, LWO) between the crystal grains (i.e., between LLZO grains), which effectively blocks lithium dendrite growth.

Compared to Comparative Sample 1 (sintering at 1170° C.) and Comparative Sample 2 (sintering at 1230° C.), relative density of the samples with LWO additive (Samples 1-8) is increased. An in-situ Li₂O atmosphere provided by LWO helps promote LLZO densification. LWO has lower melting point (742° C.) than LLZO sintering temperature, meaning that when sintering is conducted at temperatures beyond the LWO melting point (e.g., as in Step 8 in Example 4), the formed LWO liquid phase can assist LLZO sintering such that LLZO can be densified at a lower sintering temperature.

FIG. 5 illustrates Raman spectra of Samples 1-3 and Comparative Sample 1. A new peak appears in the band at around 793 cm⁻¹ when LWO is added (compare Samples 1-3 with Comparative Sample 1). This peak may be assigned to the W—O bond in W-doped LLZO (the peak at 800 cm⁻¹ is assigned to vibration of W—O in Li₂WO₄ (LWO)), suggesting that tungsten (W) enters into the Zr site of LLZO. However, peaks of W—O in the LWO phase cannot be detected in the Raman spectra. This might be due to content of LWO in LLZO-LWO samples being lower than the lowest detection limit of Raman measurement.

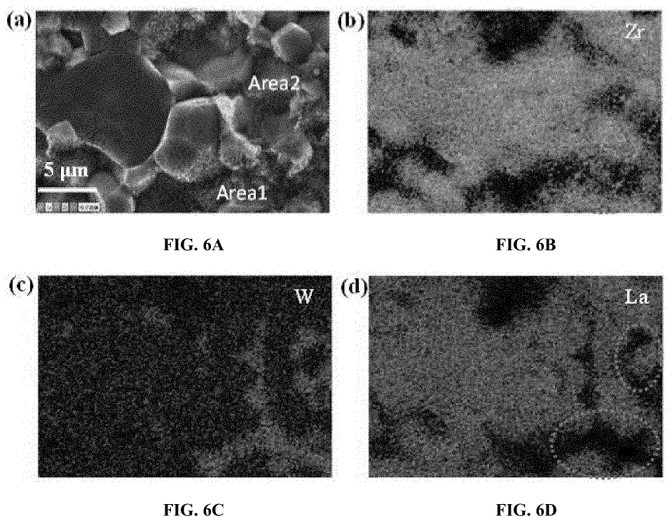

FIGS. 6A-6D illustrate cross-sectional analysis of Sample 3, including SEM (FIG. 6A) and energy dispersive spectroscopy (EDS) for elemental mapping of zirconium (Zr) (FIG. 6B), tungsten (W) (FIG. 6C), and lanthanum (La) (FIG. 6D). Area 1 and area 2 in FIG. 6A are the second phases in the LLZO composite of Sample 3. From the EDS mapping analysis, Zr (FIG. 6B) and W (FIG. 6C) are enriched, whereas La (FIG. 6D) is lacking in these two areas, indicating that the compositions are mainly Li₂WO₄ and the replacement product Li₂ZrO₃. The darker areas (circle) in FIGS. 6B and 6D are where the element is lacking. From FIG. 6C, that there many W element signals in the corresponding areas (darker area in FIGS. 6B and 6D), indicating that Li₂WO₄ aggregates in this areas. However, further comparing FIGS. 6B and 6D, Zr (FIG. 6B) is enriched, whereas La (FIG. 6D) is lacking in darker areas (circle). This is because the following reactions occur in the Li₂WO₄-rich areas, resulting in the replacement product Li₂ZrO₃-rich: Li_{6.5}La₃Zr_{1.5}Ta_{0.5}O₁₂+xLi₂WO₄→Li_{6.5-2x}La₃Zr_{1.5-x}WₓTa_{0.5}O₁₂+xLi₂ZrO₃+xLi₂O. The second phase substance existing among the LLZO grains blocks the mass transfer among the LLZO crystal grains, inhibits their growth, and causes LLZO to be sintered in a wider temperature range.

Thus, as presented herein, this disclosure relates to improved lithium-garnet composite ceramic electrolytes for enhanced grain boundary bonding of Li-garnet electrolytes in solid-state lithium metal battery applications.

Specifically, this application discloses a Li-garnet composite ceramic comprising a lithium garnet cubic major phase (e.g., LLZO, as defined above) and a lithium dendrite growth inhibitor minor phase (e.g., SA, as defined above). In some examples, the major phase may be doped with at least one of In, Si, Ge, Sn, Sb, Sc, Ti, Hf, V, W, Te, Nb, Ta, Al, Ga, Fe, Bi, Y, Mg, Ca, or combinations thereof. The composite was prepared by adding a second additive oxide (e.g., lithium-tungstate composite oxides (LiₓWO_{(x+6)/2}, ⅓≤x≤6, LWO)) into LLZO (with or without various element doping) powder and then sintered. Thus, the composite ceramic is comprises a main LLZO phase and a second phase (Li₂WO₄ and Li₂ZrO₃). The addition of the lithium-tungsten composite oxides can reduce the sintering temperature and broaden the sintering temperature window of LLZO. Performance of the composite electrolyte improves, with the critical current density (CCD) of the lithium garnet composite being higher than 1.0 mA·cm⁻² and a relative density of the lithium garnet composite being higher than 97%.

Advantages include: (A) a higher critical current density (CCD, 1 mA·cm⁻²) (composite garnet electrolyte has high CCD since the tight bonding—generated by addition of LWO—between the crystal grains can effectively block lithium dendrite growth); (B) a higher relative density (>97%) (composite garnet electrolyte has high relative density since in-situ Li₂O atmosphere provided by LWO promotes LLZO densification and the replacement of Zr by W promotes pores excluding); (C) a lower sintering temperature (e.g., 1130° C.) (LWO has a melting point lower than the sintering temperature of LLZO; thus the liquid phase can help densify LLZO at a lower sintering temperatures); (D) a wider sintering temperature range (e.g., 1130° C. to 1230° C.) (the second phase substance existing among the LLZO grains blocks mass transfer among LLZO crystal grains, inhibits their growth, and causes LLZO to be sintered in a wider temperature range).

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A sintered composite ceramic, comprising:
a lithium-garnet major phase; and
a lithium dendrite growth inhibitor minor phase,
wherein the lithium dendrite growth inhibitor minor phase comprises lithium tungstate.

2. The sintered composite ceramic of claim 1, wherein the lithium-garnet major phase comprises at least one of:
(i) Li₇₋₃ₐLa₃Zr₂LₐO₁₂, with L=Al, Ga or Fe and 0<a<0.33;
(ii) Li₇La_{3-b}Zr₂M_{b}O₁₂, with M=Bi, Ca, or Y and 0<b<1;
(iii) Li_{7-c}La₃(Zr_{2-c}, N_{c})O₁₂, with N=In, Si, Ge, Sn, Sb, Sc, Ti, Hf, V, W, Te, Nb, Ta, Al, Ga, Fe, Bi, Y, Mg, Ca, or combinations thereof and 0<c<1,
or a combination thereof.

3. The sintered composite ceramic of claim 1, wherein the lithium tungstate comprises a formula of LiₓWO_{(x+6)/2}, where ⅓≤x≤6 (LWO).

4. The sintered composite ceramic of claim 1, wherein the lithium tungstate comprises at least one of: Li₂WO₄, Li₄WO₅, Li₆WO₆, Li₂W₂O₇, Li₂W₄O₁₃, Li₂W₆O₁₅, or a combination thereof.

5. The sintered composite ceramic of claim 1, wherein the lithium-garnet major phase comprises at least 90 wt. % of a lithium garnet cubic phase.

6. The sintered composite ceramic of claim 1, wherein a maximum grain size measured for a population of grains representing at least 5% of a total grain population does not exceed an average grain size of the total grain population by more than a multiple of 20.

7. A battery, comprising:
at least one lithium electrode; and
an electrolyte in contact with the at least one lithium electrode,
wherein the electrolyte is a lithium-garnet composite electrolyte comprising the sintered composite ceramic of claim 1.

8. The battery of claim 7, having an ionic conductivity greater than 0.4 mS·cm⁻¹.

9. The battery of claim 7, having a relative density greater than 97%.

10. The battery of claim 7, having a critical current density (CCD) greater than 0.7 mA·cm⁻².

11. A method, comprising:
sintering a metal oxide component and a garnet component at a temperature in a range of 750° C. to 1500° C. to form a sintered composite ceramic, comprising:
a lithium-garnet major phase; and
a lithium dendrite growth inhibitor minor phase,
wherein the lithium dendrite growth inhibitor minor phase comprises lithium tungstate.

12. The method of claim 11, wherein the temperature is in a range of 1000° C. to 1250° C.

13. The method of claim 12, wherein the temperature is in a range of 1130° C. to 1230° C.

14. The method of claim 11, wherein prior to the step of sintering, mixing the metal oxide component and the garnet component such that a lithium-to-tungsten molar ratio (Li:W) is in a range of ⅓≤x≤6.

15. The method of claim 11, wherein the sintering is conducted for a time in a range of 1 min to 300 min.

16. The method of claim 15, wherein the sintering time is in a range of 5 min to 100 min.

17. The method of claim 11, wherein the sintering further comprises adding a garnet-type mother powder.

18. The method of claim 11, wherein the lithium tungstate comprises a formula of LiₓWO_{(x+6)/2}, where ⅓≤x≤6 (LWO).

19. The method of claim 11, wherein the lithium tungstate comprises at least one of: Li₂WO₄, Li₄WO₅, Li₆WO₆, Li₂W₂O₇, Li₂W₄O₁₃, Li₂W₆O₁₅, or a combination thereof.
